(19) United States
(12) Patent Application Publication
(10) Pub. No.: US 2024/0208812 A1
(43) Pub. Date: Jun. 27, 2024

(54) METHOD FOR MIXING AT LEAST TWO GASES

(71) Applicant: L'Air Liquide, Société Anonyme pour l'Etude et l'Exploitation des Procédés Georges Claude, Paris (FR)

(72) Inventors: Michael A. TURNEY, Houston, TX (US); Andre BAUER, Katowice (PL); Alain GUILLARD, Dana Point, CA (US); Alexander ROESCH, Butzbach (DE)

(21) Appl. No.: 18/085,667

(22) Filed: Dec. 21, 2022

(51) Int. Cl. C01B 3/50; B01D 53/047; B01D 53/22; C01B 3/56

(52) U.S. Cl. CPC C01B 3/501; B01D 53/047; B01D 53/229; C01B 3/56; C01B 2203/0405; C01B 2203/042; C01B 2203/048

(57) ABSTRACT

A method for separating hydrogen from a hydrogen-containing hydrocarbon stream, including introducing a hydrogen-containing hydrocarbon stream into a membrane separation unit, thereby producing a hydrogen-lean hydrocarbon retentate stream and hydrogen-rich permeate stream. Wherein the hydrogen-containing hydrocarbon stream has greater than 50 mol % hydrogen. And wherein the hydrogen-lean hydrocarbon retentate stream has more than 5 mol % hydrogen and less than 20 mol % hydrogen.

### BACKGROUND

One of the key challenges to the hydrogen energy transition process is the transport of renewable hydrogen to the end consumers, which will be produced, for example, by means of solar/wind energy and electrolysis in remote locations. This hydrogen may be either liquefied and transported by trailers or it may be injected into existing natural gas pipelines and transported and distributed via these pipelines. Transportation via pipeline has the advantage of continuous availability, lower energy consumption than hydrogen liquefaction and avoidance of additional carbon dioxide emissions by road transport.

While the hydrogen might be mixed into existing pipelines at the point of production up to the mechanical allowable limit (e.g. >50 mol %), comprehensive and differing local regulations and material constraints exist for existing natural gas pipeline grids in receiving/consuming locations (e.g. 5-20 mol %). It is desirable to have an effective method of reducing the hydrogen content that is possible at the point of production to meet the requirements for local natural gas pipelines This invention focuses on the adjustment of the hydrogen content at the injection point to the receiving natural gas grid.

While this specific application is not yet existing, the recovery of hydrogen from methane is a very well documented and applied process, using for example membranes or Pressure Swing Adsorption (PSA) technology. This includes hydrogen recovery from recycle streams of hydrocrackers and hydrotreaters as well as Continuous Catalytic Reforming (CCR) units. Those streams typically contain a similar high amount of hydrogen (typically 50 mol %-95 mol %) and various hydrocarbons such as C1, C2, C3 and C4+ hydrocarbons and focus on recovering as much hydrogen as possible at the highest possible purity.

Instead of recovering hydrogen, the present invention makes use of those proven separation processes to develop a solution to reject the hydrogen, i.e. to adjust the hydrogen content from >50 mol % to the maximum limit in line with local regulations (5 mol %-20 mol %) while allowing a high flexibility in fluctuating concentrations in the feed gas.

There are currently several solutions known in the art to transport renewable hydrogen to the end consumers. The first is liquefaction or pressurization of hydrogen and transport by trailers. While liquefaction itself is a very energy-intensive process, the transport by trailers adds additional carbon dioxide emissions during the transport. Furthermore, the hydrogen is not available on a continuous basis but dependent on the logistics chain.

The second current solution is to transport the hydrogen by dedicated hydrogen pipelines. Dedicated hydrogen pipelines are only existing in very rare cases and require huge investments. The third current solution is injection into the existing natural gas grid. Local regulations and material constraints allow hydrogen injection of 0.5-20 mol %. This is limiting the capacity that may be transported from remote locations such as offshore wind farms or solar farms in Northern Africa to the end consumers.

There are no known current solutions that allow the transport of high volumes of renewable hydrogen from remote locations with an integrated adjustment at the interface to the national natural gas grids for the adjustment of hydrogen content.

European patent EP2979743 presents a solution to keep the hydrogen content in a hydrogen-enriched natural gas pipeline below the regulatory limits. However, this solution has two main disadvantages. The first is that this solution focuses on the adjustment of hydrogen within an existing natural gas grid, while the present invention capitalizes on the concept that supply systems have the potential to accept much higher hydrogen concentrations (>50%) and therefore focuses on the transportation of large amounts of hydrogen at high hydrogen concentrations from remote locations and adjustment at the interface to the existing natural gas grid.

The second disadvantage is that the cited patent requires a large storage (e.g. salt cavern) to enable adjustment of the hydrogen content of the pipeline. Furthermore, depending on the storage size, the concentration of hydrogen in the storage will change with time— the smaller the storage capacity, the quicker the concentration will change. Consequently, the storage will need to be purged or released to the pipeline from time to time. Hence, the requirement of a big storage, change of concentration in the storage and the target to fulfil regulatory requirements within the local grid significantly limit this solution.

Chinese Utility Model CN 206723836 describes a possibility of effectively mixing hydrogen that is available at a lower pressure into a natural gas grid operating at a higher pressure by use of sweep type membranes (additional inlet on the permeate side— not applicable to this invention). That utility model is not affected by the current invention, however it may be improved with the addition of this invention to further optimize the described system.

### SUMMARY

A method for separating hydrogen from a hydrogen-containing hydrocarbon stream, including introducing a hydrogen-containing hydrocarbon stream into a membrane separation unit, thereby producing a hydrogen-lean hydrocarbon retentate stream and hydrogen-rich permeate stream. Wherein the hydrogen-containing hydrocarbon stream has greater than 50 mol % hydrogen. And wherein the hydrogen-lean hydrocarbon retentate stream has more than 5 mol % hydrogen and less than 20 mol % hydrogen.

### BRIEF DESCRIPTION OF THE FIGURES

For a further understanding of the nature and objects for the present invention, reference should be made to the following detailed description, taken in conjunction with the accompanying drawings, in which like elements are given the same or analogous reference numbers and wherein:

FIG. 1 is a schematic representation a method for removing hydrogen from a hydrocarbon stream utilizing membrane separation, in accordance with one embodiment of the present invention.

FIG. 2 is a schematic representation a method for removing hydrogen from a hydrocarbon stream utilizing a first combination of membrane separation and pressure swing adsorption separation, in accordance with one embodiment of the present invention.

FIG. 3 is a schematic representation a method for removing hydrogen from a hydrocarbon stream utilizing pressure swing adsorption separation, in accordance with one embodiment of the present invention.

FIG. 4 is a schematic representation a method for removing hydrogen from a hydrocarbon stream utilizing a second combination of membrane separation and pressure swing adsorption separation, in accordance with one embodiment of the present invention.

### Element Numbers

101=(long-distance pipeline) hydrogen-rich hydrocarbon stream
102=membrane separation unit feed stream
103=membrane separation unit
104=hydrogen-lean hydrocarbon stream (retentate)
105=national regional natural gas pipeline
106=hydrogen-rich stream (permeate)
107=hydrogen pipeline/hydrogen consumer
108=locally utilized portion of hydrogen-lean hydrocarbon stream
109=locally utilized portion of hydrogen-rich stream
110=hydrogen-rich stream compressor (optional)
111=pipeline compression station compressor
112=pipeline compression station heat exchanger (optional)
113=heat transfer fluid (optional)
114=membrane separation unit feed stream heat exchanger (optional)
201=(long-distance pipeline) hydrogen-rich hydrocarbon stream
202=membrane separation unit feed stream
203=membrane separation unit
204=hydrogen-lean hydrocarbon stream (retentate)
205=hydrogen-enriched stream (permeate)
206=pressure swing adsorption unit
207=high-purity hydrogen stream
208=PSA tail gas stream
209=combined hydrogen-lean hydrocarbon stream
210=national regional natural gas pipeline
211=hydrogen pipeline/hydrogen consumer
212=locally utilized portion of hydrogen-lean hydrocarbon stream
213=locally utilized portion of hydrogen-rich stream
214=hydrogen-enriched stream compressor (optional)
215=pipeline compression station compressor
216=pipeline compression station heat exchanger (optional)
217=heat transfer fluid (optional)
218=membrane separation unit feed stream heat exchanger (optional)
219=PSA tail gas stream compressor
220=compressed PSA tail gas stream
221=combined natural gas pipeline feed stream
301=(long-distance pipeline) hydrogen-rich hydrocarbon stream
302=pressure swing adsorption unit feed stream
303=pressure swing adsorption unit
304=high-purity hydrogen stream
305=hydrogen pipeline/hydrogen consumer
306=PSA tail gas stream
307=national regional natural gas pipeline
308=locally utilized portion of hydrogen-rich stream
309=locally utilized portion of hydrogen-lean hydrocarbon stream
310=PSA tail gas stream compressor
311=compressed PSA tail gas stream
312=combined natural gas pipeline feed stream
401=(long distance pipeline) hydrogen-rich hydrocarbon stream
402=PSA unit feed stream
403=pressure swing adsorption unit
404=PSA tail gas stream
405=high purity H2 stream
406=tail gas compressor
407=compressed tail gas stream
408=membrane separation unit
409=hydrogen-enriched stream (permeate)
410=hydrogen-lean hydrocarbon stream (retentate)
411=H2 stream to pipeline
412=H2 pipeline
413=hydrogen-lean hydrocarbon consumer
414=national regional natural gas pipeline
415=hydrogen-enriched stream compressor
416=compressed PSA unit feed stream
417=combined PSA unit feed stream
418=pipeline compression station compressor
419=pipeline compression station heat exchanger (optional)
420=heat transfer fluid (optional)
421=membrane separation unit feed stream heat exchanger (optional)
422=locally utilized portion of hydrogen-rich stream

### DESCRIPTION OF PREFERRED EMBODIMENTS

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

A solution has been developed that allows long-distance transport of hydrogen via pipeline and direct injection into existing natural gas grids by adjusting the hydrogen level to the local regulations and/or local constraints with respect to material of construction, consumer requirements etc.

To address this deficiency within the industry, several studies have been performed based on comprehensive data from existing operating hydrogen membrane and PSA units in refinery and natural gas applications by transformation of these data to the above-mentioned objectives.

Renewable hydrogen may be produced by electrolysis using renewable energy such as wind or solar energy at remote locations. At the place of production, the hydrogen may be directly injected into an existing natural gas pipeline at mechanically highest possible hydrogen concentration—preferably higher than 20 mol %, most preferably higher than 50 mol % of hydrogen—to transport it to an existing natural gas pipeline grid.

At the interface to the existing natural gas pipeline grid, the hydrogen content must be adjusted to comply with local regulations and/or material constraints before being further distributed to the end consumers. Local regulations provide restrictions for the transport of hydrogen in the existing natural gas pipeline grid in the range of 5 mol % to 20 mol %. This invention describes a process to adjust the hydrogen content of the transport pipeline (preferable >50 mol %) to the allowable limit of the existing natural gas pipeline grid (5 mol %-20 mol %).

It has been found that membranes are able to address the requirement mentioned above, either as standalone systems in 1-stage, 2-stage or 3-stage set-up or in combination with a PSA for purification of the resulting surplus hydrogen that may be then processed further or used for H2 mobility purposes.

Transport pipelines are normally operating at higher pressures (typically >80-100 bar) than the natural gas pipeline grid (typically 40-80 bar), thus allowing for a certain pressure drop at the injection point to the natural gas grid, which will make the use of membranes for hydrogen rejection at the injection point to the natural gas grid an economic and efficient means and reduce the energy required for recompression of the hydrogen-rich permeate stream.

The studies have shown that especially commercially available polymeric membranes, preferably polyimide based hollow fiber membranes or other membrane types that are conventionally used for hydrogen recovery from refinery off gas, are suitable for this purpose— including membranes based on cellulose acetate, polysulfone, polyimide, polyamide, polyaramide et al.

Membranes are applied due to the following advantages:
High flexibility to fluctuating hydrogen content in the transportation pipeline,
The adjusted stream is available at high pressure,
Specification of natural gas according to international regulations can be met with conventionally available hydrogen membrane modules (e.g. polyimide based hollow fibre membranes),
Easy adjustment to different capacities,
Not sensitive to O2/CO2 content and other impurities in the pipeline.
By use of skid-mounted membrane units, easy-to-install modularized solutions can be developed and installed at the interconnection points between transport pipelines and the natural gas grid (e.g. at country borders), which can be easily revamped by adding additional membrane vessels.
Membranes achieve a higher hydrogen recovery to the permeate stream (typically >90-95%) than a PSA (typically 85-90%), i.e. it is more efficient to remove hydrogen from a hydrogen-rich natural gas stream by a membrane.

The present invention describes a process for the reduction of the hydrogen content in a pipeline by separation of hydrogen (>50 mol %) from the hydrogen transport pipeline down to 5-20 mol % in order to comply with local regulations of the existing natural gas grid.

Part of the hydrogen-enriched natural gas stream is sent to the membrane, which may be a 1-stage or 2-stage or 3-stage membrane. The hydrogen-depleted natural gas with a hydrogen content of 5-20 mol % leaves the membrane as retentate at a similar pressure as the feed pressure. Typically, a pressure drop of 0.5-2 bar is assumed. The permeate stream leaves the membrane enriched in hydrogen. Depending on the hydrogen in the feed gas and the feed gas pressure, this hydrogen content may vary between 50-99.9 mol %. The permeate stream at approx. 2 bar-15 bar may be compressed and further purified by a PSA to a purity level of 99.9 mol % and above (up to 99.999 mol %) and used for example. for hydrogen mobility purposes. Alternatively, it may be mixed with syngas from a steam reforming unit upstream of the PSA to reduce the carbon intensity of the hydrogen produced by the steam reformer.

If the required purity of the natural gas cannot be reached in a one stage membrane, for example in systems with very high hydrogen content in the transportation pipeline and/or lower feed pressure (e.g. 20-30 bar), the retentate stream is being sent to a second (and eventually third) membrane stage to further reduce the hydrogen content. Each permeate stream is rich in hydrogen and may be compressed and further purified in a PSA.

The system may contain one or several heaters (e.g. steam heated, electrical heated, natural gas heated or hot oil or water bath heaters, heated by compression heat) to heat up the feed to the membranes to an optimum temperature, which is in the range of 30-100° C. The higher the temperature, the lower the residual content of hydrogen in the retentate stream at a given number of membrane counts. Therefore, a high temperature is preferred, however this may require implementation of a cooler downstream of the membrane. A coalescer to remove particles and moisture to increase the lifetime is usually part of the membrane unit and installed upstream of the membrane modules.

The overall set-up is defined by feed pressure and temperature and hydrogen content in the feed gas. The system is then designed in an iterative manner to optimize costs for the membrane unit and compressor. The lower the permeate pressure, the lower the costs of the membrane, however the higher the compressor costs. In practice, a 2-stage or 3-stage compressor will define a reasonable permeate pressure.

The system is very flexible in terms of feed composition and pressure. It may be controlled by variation in the temperature (a higher temperature will result in lower hydrogen content in the retentate) and permeate pressure (a lower permeate pressure will result in lower hydrogen content in the retentate)

Final purification of the hydrogen-rich stream (permeate) can be achieved with PSA to obtain purities of 99.9 mol % and higher. The resulting PSA tail gas stream may be compressed and injected into the natural gas grid.

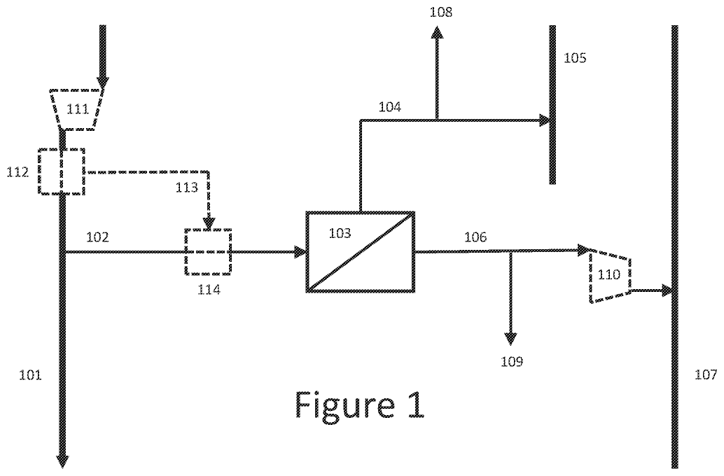

Turning to FIG. 1, method of reducing the hydrogen concentration of a hydrogen-rich hydrocarbon stream in order to produce a hydrogen-rich stream and a hydrogen-lean hydrocarbon stream is illustrated. Membrane separation unit feed stream 102 is withdrawn from a long-distance pipeline that transports hydrogen-rich hydrocarbon stream 101. Membrane separation unit feed stream 102 is introduced into membrane separation unit 103, thereby producing hydrogen-lean hydrocarbon retentate stream 104, and hydrogen-rich permeate stream 106. A portion 108 of hydrogen-lean hydrocarbon stream 104 may then be utilized locally. All or a portion of hydrogen-lean hydrocarbon retentate stream 104 may be introduced into national regional natural gas pipeline 105. A portion 109 of hydrogen-rich permeate stream 106 may then be utilized locally. All or a portion of hydrogen-rich permeate stream 106 may be introduced into hydrogen pipeline 107. A portion of hydrogen-rich permeate stream 106 may be introduced into hydrogen-rich stream compressor 110 to elevate the pressure if necessary, prior to introduction into hydrogen pipeline 107.

Long distance pipelines, such as hydrogen-rich hydrocarbon stream pipeline 101, have compressor stations located along the length in order to maintain a minimum pipeline pressure. Pipeline compression station compressor 111 will add unwanted and undesirable heat to the gas stream. Optional pipeline compression station heat exchanger 112 transfers at least a portion of this additional heat into heat transfer fluid 113. Heat transfer fluid 113 then may introduce at least a portion of this useful heat into optional membrane separation unit feed stream heat exchanger 114, thus heating membrane separation unit feed stream and improving the membrane and overall system efficiency.

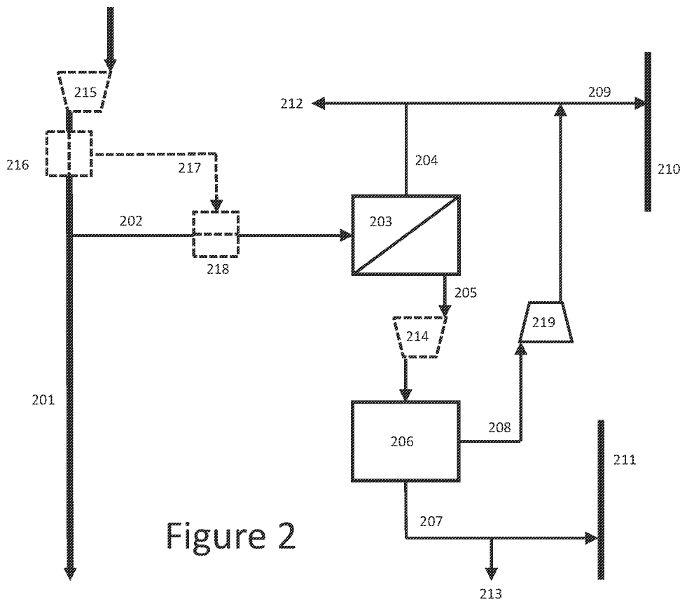

Turning to FIG. 2, another method of reducing the hydrogen concentration of a hydrogen-rich hydrocarbon stream in order to produce a hydrogen-rich stream and a hydrogen-lean hydrocarbon stream is illustrated. Membrane separation unit feed stream 202 is withdrawn from a long-distance pipeline that transports hydrogen-rich hydrocarbon stream 201. Membrane separation unit feed stream 202 is introduced into membrane separation unit 203, thereby producing hydrogen-lean hydrocarbon retentate stream 204, and hydrogen-rich permeate stream 205. A portion 212 of hydrogen-lean hydrocarbon stream 204 may then be utilized locally. Hydrogen-rich permeate stream 205 is introduced into pressure swing adsorption unit 206, thereby producing high-purity hydrogen stream 207 and PSA tail gas stream 208. Hydrogen-rich permeate stream 205 may be introduced into optional hydrogen-enriched stream compressor to increase the pressure if needed. A portion 213 of high-purity hydrogen stream 207 may then be utilized locally. All or a portion of high-purity hydrogen stream 207 may be introduced into hydrogen pipeline 211. PSA tail gas stream 208 enters PSA tail gas stream compressor 219, thereby elevating the pressure and producing compressed PSA tail gas stream 220. Compressed PSA tail gas stream 220 is then combined with all or a portion of hydrogen-lean hydrocarbon stream 204, and all or a portion of combined hydrogen-lean hydrocarbon stream 209 may be introduced into national regional natural gas pipeline 210. National regional natural gas pipeline 210 may be a low-pressure natural gas pipeline. National regional natural gas pipeline 210 may have an operating pressure of less than 25 bara. Membranes achieve a higher hydrogen recovery to the permeate stream (typically >90-95%) than a PSA (typically 85-90%), i.e. the PSA tailgas stream still contains a certain amount of hydrogen, which needs to be taken into account before mixing the PSA tailgas stream 208 with the retentate stream 204 and injecting it into the local natural gas grid to ensure that the maximum limit will not be exceeded.

Long distance pipelines, such as hydrogen-rich hydrocarbon stream pipeline 201, have compressor stations located along the length in order to maintain a minimum pipeline pressure. Pipeline compression station compressor 215 will add unwanted and undesirable heat to the gas stream. Optional pipeline compression station heat exchanger 216 transfers at least a portion of this additional heat into heat transfer fluid 217. Heat transfer fluid 217 then may introduce at least a portion of this useful heat into optional membrane separation unit feed stream heat exchanger 218, thus heating membrane separation unit feed stream and improving the membrane and overall system efficiency.

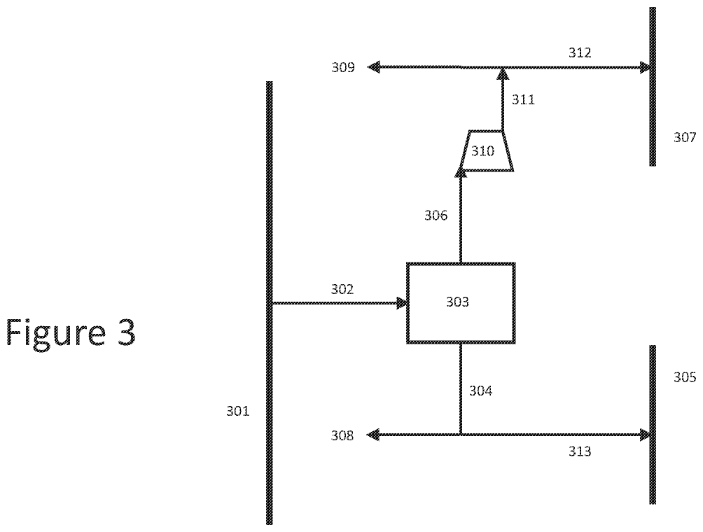

Turning to FIG. 3, another method of reducing the hydrogen concentration of a hydrogen-rich hydrocarbon stream in order to produce a hydrogen-rich stream and a hydrogen-lean hydrocarbon stream is illustrated. Pressure swing adsorption unit feed stream 302 is withdrawn from a long-distance pipeline that transports hydrogen-rich hydrocarbon stream 301. Pressure swing adsorption unit feed stream 302 is introduced into pressure swing adsorption unit 303, thereby producing high purity hydrogen stream 304 and PSA tail gas stream 306. A portion 308 of high purity hydrogen stream 304 may then be utilized locally. All or a portion 313 of high purity hydrogen stream 304 may be introduced into hydrogen pipeline 305. PSA tail gas stream 306 enters PSA tail gas stream compressor 310, thereby elevating the pressure and producing compressed PSA tail gas stream 311. A portion 309 of compressed PSA tail gas stream 311 may then be utilized locally. All or a portion 312 of the compressed PSA tail gas stream 311 may be introduced into national regional natural gas pipeline 307. National regional natural gas pipeline 307 may be a low-pressure natural gas pipeline. National regional natural gas pipeline 307 may have an operating pressure of less than 25 bara.

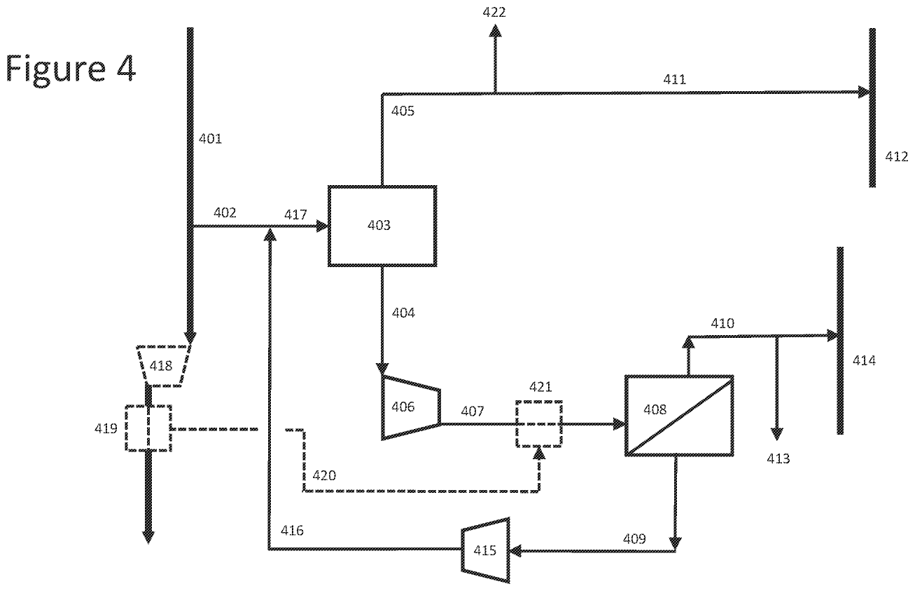

Turning to FIG. 4, another method of reducing the hydrogen concentration of a hydrogen-rich hydrocarbon stream in order to produce a hydrogen-rich stream and a hydrogen-lean hydrocarbon stream is illustrated. Pressure swing adsorption unit feed stream 402 is withdrawn from a long-distance pipeline that transports hydrogen-rich hydrocarbon stream 401. Pressure swing adsorption unit feed stream 402 is introduced into pressure swing adsorption unit 403, thereby producing high-purity hydrogen stream 405 and PSA tail gas stream 404. A portion 422 of hydrogen stream 405 may then be utilized locally and remainder 411 sent to hydrogen pipeline 412. Hydrogen-lean tail gas stream 404 is then introduced into tail gas compressor 406, thereby producing compressed hydrogen-lean stream 407. Compressed hydrogen-lean stream 407 is then introduced into membrane separation unit 408, thereby producing hydrogen-lean hydrocarbon retentate stream 410, and hydrogen-rich permeate stream 409. A portion 413 of hydrogen-lean stream 410 may then be utilized locally. All or a portion of hydrogen-lean stream 410 may be introduced into hydrogen-lean hydrocarbon pipeline 414. PSA tail gas stream 409 is compressed in PSA tail gas compressor 415 thereby producing compressed PSA tail gas stream 416 and combined with PSA feed stream 402, thereby producing combined PSA unit feed stream 417, which is then introduced into pressure swing adsorption unit 403.

Long distance pipelines, such as hydrogen-rich hydrocarbon stream pipeline 401, have compressor stations located along the length in order to maintain a minimum pipeline pressure. Pipeline compression station compressor 418 will add unwanted and undesirable heat to the gas stream. Optional pipeline compression station heat exchanger 419 transfers at least a portion of this additional heat into heat transfer fluid 420. Heat transfer fluid 420 then may introduce at least a portion of this useful heat into optional membrane separation unit feed stream heat exchanger 421, thus heating membrane separation unit feed stream and improving the membrane and overall system efficiency.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A method for separating hydrogen from a hydrogen-containing hydrocarbon stream, comprising introducing a hydrogen-containing hydrocarbon stream into a membrane separation unit, thereby producing a hydrogen-lean hydrocarbon retentate stream and hydrogen-rich permeate stream,
wherein the hydrogen-containing hydrocarbon stream comprises greater than 50 mol % hydrogen, and
wherein the hydrogen-lean hydrocarbon retentate stream comprises more than 5 mol % hydrogen and less than 20 mol % hydrogen.

2. The method of claim 1, wherein the hydrogen-lean hydrocarbon retentate stream comprises less than 10 mol % hydrogen.

3. The method of claim 1, further comprising introducing the hydrogen-rich permeate stream into a pressure swing adsorption unit, thereby producing a high-purity hydrogen stream and a PSA tail gas stream,
wherein the high-purity hydrogen stream comprises greater than 99.9 mol % hydrogen.

4. A method for separating hydrogen from a hydrogen-containing hydrocarbon stream, comprising introducing a hydrogen-containing hydrocarbon stream into a pressure swing adsorption unit, thereby producing a high-purity hydrogen stream and a PSA tail gas stream,
wherein the high-purity hydrogen stream comprises greater than 99.0 mol % hydrogen, and
wherein the PSA tail gas stream is introduced into a low-pressure natural gas pipeline.

5. The method of claim 4, wherein the low-pressure natural gas pipeline operates at a pressure of less than 25 bara.

6. The method of claim 4, further comprising introducing the PSA tail gas stream into a membrane separation unit, thereby producing a hydrogen-lean hydrocarbon retentate stream and hydrogen-rich permeate stream,
wherein the hydrogen-lean hydrocarbon retentate stream comprises less than 20 mol % hydrogen.

7. The method of claim 6, further comprising returning at least a portion of the hydrogen-rich permeate stream to the PSA feed.
